(19) United States
(12) Patent Application Publication
(10) Pub. No.: US 2013/0236393 A1
(43) Pub. Date: Sep. 12, 2013

(54) HYDROGEN-GENERATING COLLOIDAL SUSPENSION

(71) Applicant: UNITHER DEVELOPPEMENT, Amiens (FR)

(72) Inventor: Marc MAURY, Saint Medard En Jalles (FR)

(73) Assignee: UNITHER DEVELOPPEMENT, Amiens (FR)

(21) Appl. No.: 13/859,942

(22) Filed: Apr. 10, 2013

Related U.S. Application Data
(63) Continuation-in-part of application No. 13/000,956, filed on Dec. 22, 2010, now abandoned.

(30) Foreign Application Priority Data
Jun. 25, 2008 (FR) 0854233

(51) Int. Cl. C01B 3/08

(52) U.S. Cl. CPC C01B 3/08
USPC 423/657

(57) ABSTRACT

The use of a colloidal suspension that comprises between 35% and 60% of alkaline metal particles that are suspended in a neutral hydrophobic diluent for producing gaseous hydrogen, as well as a process for producing hydrogen. Also, a hydrogen-generating device and its use.

### FIELD OF THE INVENTION

This invention relates to the use of a particular composition for producing gaseous hydrogen.

The invention also relates to a hydrogen-generating device starting from this composition and its use for supplying a fuel cell.

### BACKGROUND OF THE INVENTION

The reduction of hydrocarbon stocks and the pollution problems of cities make necessary the development of new energies that are more available and less polluting than petroleum products.

One of the many paths explored for this purpose is the use of a fuel cell that makes it possible to produce electricity from hydrogen and oxygen.

Hydrogen is actually a vector fuel for energy per se; when it combusts with the oxygen of the air, it releases significant energy, producing only water.

However, the use as hydrogen fuel has always been confronted with problems of production and storage before its use, in particular for the on-board applications, which until now prevented large-scale development of this energy vector.

Despite a huge number of work, publication and patent, the storage of hydrogen is a problem that is technically difficult to solve.

The most compact storage in liquid form requires a cryogenic cooling at very low temperature and the design of reservoirs that are suitable for use in motor vehicles with extremely advanced insulation.

In addition, it is difficult to envision storing liquid hydrogen in a small quantity over long periods. Currently, the best reservoir prototypes make it possible to store the hydrogen for a period that is less than 1 month, because beyond that, the losses of hydrogen are enormous.

Hydrogen can also be stored in gaseous form. Nevertheless, taking into account the low molar mass of hydrogen, the storage in compressed form makes it possible to store only a small quantity of hydrogen, and because of the small size of the hydrogen molecules, leaks systemically appear by porosity. The extended and secure storage of hydrogen in gaseous form is therefore very limited.

It is also known that it is possible to store hydrogen in structures that absorb it in a reversible way. This storage method, which uses materials that have a more or less high affinity with hydrogen, makes possible a good storage capacity but always requires the manipulation of liquid or gaseous hydrogen. Furthermore, these storage systems in hydride form require the installation of a heating system to make possible the desorption of hydrogen.

There is therefore currently no suitable system for storing hydrogen. Another difficulty that slows the development of the hydrogen as an energy vector is its difficulty in being obtained.

The prior art describes several methods for the production of hydrogen, such as, in particular, the production by electrolysis of water, the production by reaction of water vapor that is superheated on carbon, hydrocarbon cracking, reforming of alcohol such as methanol or ethanol, or else the production by reaction of water on alkaline metals or borohydrides.

However, these methods for producing hydrogen require complex installations and an important energy source, which makes the production of hydrogen by the known methods difficult to integrate in a portable device.

The different constraints that are associated with storage and with the production of hydrogen therefore currently prevent large-scale development of this energy source.

There is thus still a need for a secure and high-performing system that makes it possible to use hydrogen, suitable for mobile applications.

This is the purpose of this invention that proposes to use a composition that can generate hydrogen by chemical reaction only when its use is necessary, without there being a need to store it.

In particular, the purpose of the invention is a composition that is designed for the production of hydrogen that comes in the form of a colloidal suspension that comprises between 35% and 60% of alkaline metal particles that are suspended in a neutral hydrophobic diluent.

Reactions of sodium with water to produce hydrogen or hydrochloric acid have been known for a long time, since the work of Humpfrey Davy in the 1800s. However, no feasible industrial method has been proposed to date, and there is no known method for correct and safe hydrogen production using reactions of sodium with water.

Indeed, the reaction of sodium with water is an extremely violent reaction releasing hydrogen in addition to a very large quantity of thermal energy. This double release makes it difficult to control the chemical reaction, which makes the use of sodium in the release of hydrogen virtually impossible in that state.

Recent accidents using lithium batteries (Boeing 787), in which the batteries spontaneously ignited, demonstrates that this problem of safety for the application utilizing alkaline metals is still valid, and that no method has allowed for the development of a solution for safe and efficient hydrogen production from an alkaline metal base.

In addition, the publication of Keneshea et al. (“Sodium Conversion Experiments Inert Carrier Process in the Demonstration Plant” Nuclear and Chemical Waste Management, Vol. 4 pp. 189-199, 1983) describes a method for reprocessing contaminated sodium in nuclear reactors of the super generator type. This document does not directly concern the production of hydrogen, but it indicates the possibility of removing sodium in an inert carrier and then carrying out a neutralization reaction with water or hydrochloric acid to form either sodium hydroxide or sodium chloride, which can be easily collected and decontaminated. Nevertheless, this paper shows that this solution is not satisfactory and feasible because the reaction causes the formation of a very important stable foam, impossible to control even with the addition of an anti-foaming agent. The sodium reprocessing industry as described in this document has also been completely abandoned since the control of operations and formation of foam could not be resolved.

### SUMMARY OF THE INVENTION

Advantageously, the method according to the present invention, by using a particular concentration of alkaline metal never before imagined because of its high value, solves these problems. The formulation is stable during the reaction and no foam is formed. The method thus ensures a fine control of the production of hydrogen and protection against accidental mixing with water.

The invention also covers a process for the production of hydrogen from this composition. Its purpose is also a device for producing hydrogen that comprises this composition and the use of this device for any application that requires hydrogen, for example for supplying a fuel cell or a thermal combustion engine.

“Colloidal suspension” is defined as any more or less viscous liquid composition that contains small particles in suspension.

### BRIEF DESCRIPTION OF THE DRAWINGS

The invention is now described in detail with regard to the accompanying drawings in which:

FIG. 1 shows the diagram of a hydrogen production device according to the invention.

FIG. 2 shows a plot of results from the production of hydrogen (volume of hydrogen released) when the reaction is performed with an excess of water with respect to the colloidal suspension (20 mL of a sodium solution according the invention+10 mL of water).

FIG. 3 shows a plot of results from the production of hydrogen (volume of hydrogen released) when the reaction is performed without an excess of water with respect to the colloidal suspension (20 mL of sodium solution according to the invention+60 μL of water).

### DETAILED DESCRIPTION OF THE INVENTION

The composition that is intended for the production of hydrogen according to the invention comprises between 35% and 60% of alkaline metal particles that are suspended in a neutral hydrophobic diluent (the percentage is given in w/w). This proportion of alkaline metal particles in the colloidal suspension is particularly suitable for the production of gaseous hydrogen on an industrial scale with an important energy density and a great safety of use. This concentration provides a stable suspension having a viscosity low enough to allow its transfer by pump systems. Preferably, even more suitably, the concentration of alkaline metal is around 40% (w/w).

The alkaline metal can be selected in particular from among sodium or lithium. Preferably, the suspension according to the invention comprises more abundant and less expensive metallic sodium particles

The alkaline metal comes in the form of particles of very small size, even nanoparticulate. According to a particularly suitable embodiment, the size of the particles is less than 15 μm. Preferably, it is between 0.1 and 10 μm, even more preferably between 0.1 and 5 μm.

These particles are suspended in a neutral hydrophobic diluent, such as an organic polymer that is selected from mineral oils. According to one embodiment, the composition also comprises a dehydrating agent that makes it possible to tolerate in the suspension the presence of water in a small quantity or a trace of atmospheric moisture that can trigger premature reactions. Such a dehydrating agent is typically a composition that comprises mineral compounds in suspension such as phosphorus silica or phosphorus pentoxide, or else complex organic compounds such as zeolites.

The composition according to the invention can be obtained by, for example, the implementation of a process that comprises the following stages:
Heating sodium to a temperature that is higher than 97.5° C., preferably between 120 and 150° C., to obtain a liquid sodium solution that has this temperature,
Heating a hydrophobic diluent to an equivalent temperature that is higher than 97.5° C., preferably between 120 and 150° C., to obtain an oily solution that has this temperature,
Introducing, while being stirred, the liquid sodium solution into the oily solution,
Producing an emulsification using a colloidal grinder-type stirring turbine,
Injecting, under high pressure, the emulsion into a cooling system or a cold hydrophobic oily solution so as to recover the colloidal sodium particles.

Advantageously, the presence of the hydrophobic diluent makes it possible for the suspension to be kept in the liquid state without taking special precautions under the ambient storage conditions. The hydrophobic nature of the diluent protects the composition from accidental point contact with water, which would cause undesirable chemical reactions.

According to another advantage, the composition can be easily manipulated, is slightly viscous, and is stable at ambient temperature and pressure. It thus is possible to manipulate it easily and to store it in liquid form at ambient pressure.

The composition according to the invention is useful for producing hydrogen.

By bringing the colloidal suspension of the alkaline metal according to the invention into close contact with an aqueous solution, the water, preferably purified and demineralized, gradually reacts with the alkaline metal and generates gaseous hydrogen and an aqueous alkaline hydroxide emulsion, for example a sodium hydroxide solution.

The reaction that occurs is as follows:

2M+2H₂O→H₂+2M⁺+2HO⁻

whereby M is an alkaline metal, preferably sodium or lithium.

The reaction could be carried out without agitation. But to accelerate and control the production of hydrogen, it is possible to introduce mechanical agitation allowing faster contact of water with the metal particles.

Preferably, the aqueous solution is not present in excess with respect to the colloidal suspension comprising the alkaline metal particles. That is, the aqueous solution is not present in an amount or a volume in excess compared with the stoichiometric content of the alkaline metal M present in the colloidal suspension and with water in order to produce the reaction between M and H₂O described above. Indeed, against all odds, the presence of a small amount of water significantly increases the yields of hydrogen produced. This is an essential parameter in order to finely control the hydrogen evolution reaction. This avoids any risk of explosion and/or projection of chemical reagents.

In contrast, and equally very surprising, when the aqueous solution is present in excess, the reaction yield is very low and very diminished, and, therefore, a weak exothermic reaction is produced. The high concentration of alkali metal particles, the hydrophobic nature of the colloidal suspension according to the invention, and its being brought into the presence of natural water limits the reaction speed of the reaction and therefore the risk of accidents. Furthermore, no stable foam is formed.

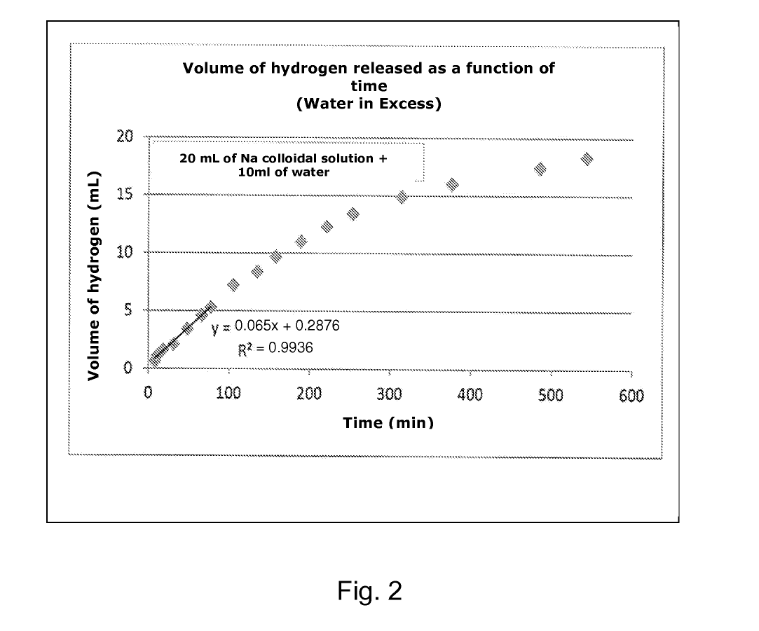

FIG. 2 shows the results from tests carried out by reacting 20 mL of a solution containing 40% (w/w) of sodium particles suspended in a neutral hydrophic diluent, with 10 mL of water, without agitation. It is noted that this leads to a very weak reaction (low production of hydrogen and weak exothermic reaction) yielding only 0.27% when the reaction involves an excess of water with respect to the colloidal suspension, without agitation.

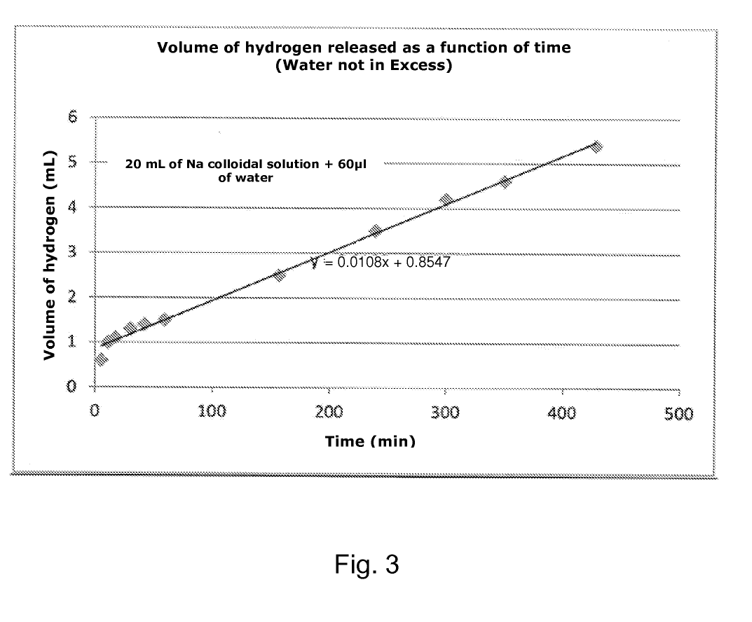

FIG. 3 shows the results from tests carried out by reacting 20 mL of a solution containing 40% (w/w) of sodium particles suspended in a neutral hydrophic diluent with 60 μL of water, without agitation. It is noted that this leads to a more significant reaction with a yield 5.9% when the reaction does not involve an excess of water with respect to the colloidal suspension, without agitation.

The use of a colloidal suspension of highly concentrated sodium is, therefore, an ideal solution for highly safe production of hydrogen to be used as a usable energy vector, including in consumer areas such as fuel, for example. Sodium particle concentrations that are too low do not allow these effects and industrial applications.

To facilitate the reaction and the contact between the colloidal sodium and water, it is possible to introduce into the aqueous solution at least one emulsifying surfactant. The surfactant make possible an emulsification of oil and thus facilitate the reaction for producing hydrogen.

The surfactant can be selected from among suitable ionic or anionic surfactants. It can be, for example, a sorbitan ester, a polyoxyethylene, a polysorbate, or else a lecithin.

Preferably, the surfactant content is between 0.05 and 2% (w/w).

The composition according to the invention can be used in a simple hydrogen-generating device in which the reagents can be stored without low-temperature or high-pressure thermal limitation.

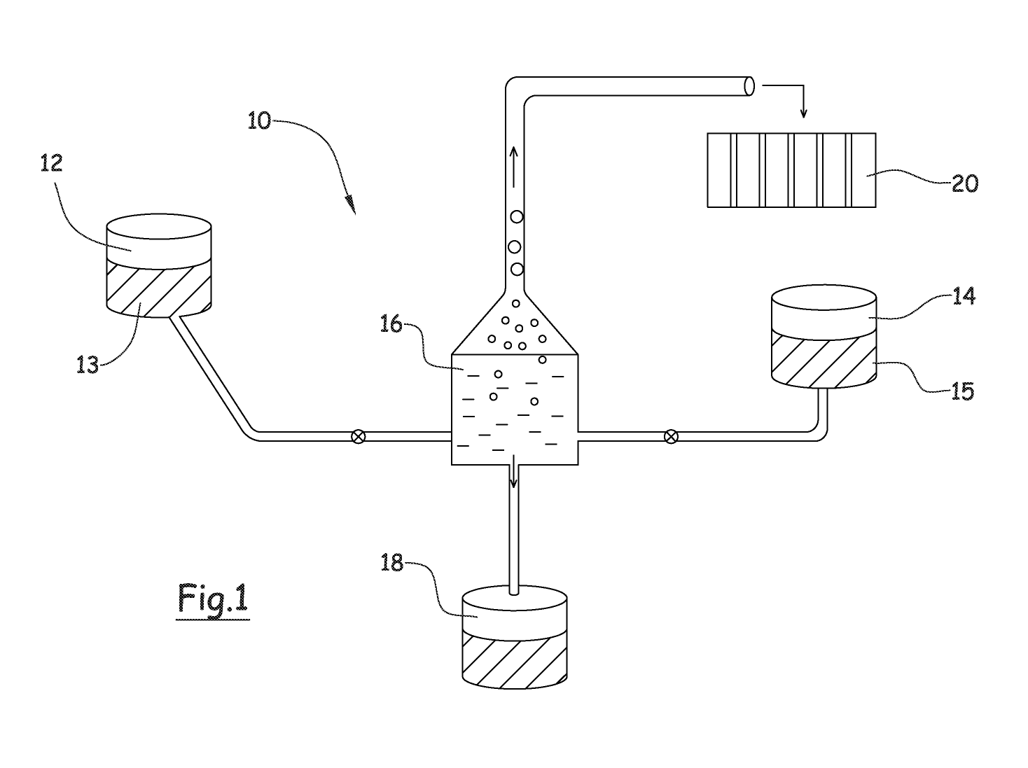

FIG. 1 shows a hydrogen-generating device 10 that comprises in particular:
A reservoir 12 for storing a composition 13 that comprises alkaline metal particles that are suspended in a neutral hydrophobic diluent,
A reservoir 14 for storing an aqueous solution 15,
A mixing chamber 16 into which the composition 13 and the aqueous solution 15 are introduced and from which the gaseous hydrogen 17 can escape. The mixing chamber 16, or reactor, can be made of stainless steel that is resistant to corrosion and to heat and may have a high-strength inner ceramic wall.

The composition 13 and the aqueous solution 15 are preferably injected under pressure into the chamber 16 using injection systems, thus avoiding any sealing problem.

The time management of the reaction in the mixing chamber 16 can be ensured by sensor devices and self-regulated injectors that allow the mixing.

According to a particularly suitable embodiment, the device 10 also comprises a reservoir 18 for recovery of hydrophobic oil and the aqueous alkaline hydroxide emulsion that are produced after reaction in the chamber 16. This reservoir 18 preferably consists of polymer material or inert composite material that is resistant to chemical attacks at very high pH.

The chamber 16 can also comprise a system for intake and grinding of sodium hydroxide crystals that are generated by the hydrogen-producing reaction.

This device is a complete portable system that makes possible the supply of a fuel cell that can be used in, for example, an electric vehicle. Actually, the hydrogen that is produced in the chamber 16 can be used to supply a fuel cell 20 with gaseous hydrogen to produce electricity with oxygen.

The device according to the invention can also be used to supply with gaseous hydrogen a low- or high-power thermal motor, or a stationary or mobile station for distribution of hydrogen, providing hydrogen upon demand and having its own independent power supply, in an ecological manner. Advantageously, the invention remedies the significant problems of storing hydrogen, which is technically difficult and dangerous.

According to another advantage, the presentation in liquid form of the composition 13 allows easy manipulation using a simple pumping system that makes it possible to transfer/meter the liquid.

In the case of a use for supplying a fuel cell, the water that is produced by the cell 20 can be reused in the aqueous solution 15 that is necessary to the reaction with the alkaline metal of the colloidal suspension 13.

The device according to the invention can also comprise a heat-exchanger-type heat recovery system, making it possible to generate mechanical power by a Sterling-engine-type device or the equivalent, or else it can be directly transformed into electricity by thermocouple devices.

In addition, the exothermy of the reaction between the alkaline metal and the water can be used in on-board systems that use the device 10 for producing, for example, heating in the passenger spaces of motor vehicles or air-conditioning by an absorption system or else the reheating of fuel cells whose conversion yield is better at a higher temperature.

Finally, according to another advantage, the hydroxide solution that is produced by the reaction between the composition according to the invention and the aqueous solution can be recycled to regenerate the alkaline metal colloidal suspension.

To illustrate the invention, the energy balance of the reaction according to the invention for a colloidal suspension of sodium at 40% w/w were calculated and are shown in the table below:

| | | | Conversion | | | |
|---|---|---|---|---|---|---|
| Sodium Mass | | | efficiency | | Autonomie | |
| NatHydro | Energy Capacity | | Stirling Engine | | possible | |
| 91 kg (4 kg H₂ produced) | $\begin{matrix}200 kWh ( exothermic reaction ) \\ + 156 kWh ( combustion {H}_{2} ) \\ = 356 kWh\end{matrix}$ | | 142 | kWh | 1097 | km |
| 45 kg | 178 | kWh | 71 | kWh | 548 | km |

Energy capacity = heat of combustion H₂ and exothermic reaction Na + H₂O

The amount of potential energy is important. The thermal energy is 200 kWh for a mass of 91 kg of sodium suspension capable of producing 4 kg of hydrogen or the energy equivalent of 156 kWh. That is, the global potential energy of 356 kWh.

If one recovers the thermal energy released by the reaction of a Stirling engine type system one can expect a thermal efficiency of about 40%, the autonomy possible for a vehicle a 45 kg embarking with 45 kg colloidal solution of sodium is of the same order as that obtained with a vehicle operating with thermal fossil hydrocarbons.

1. A method for producing gaseous hydrogen, comprising using a colloidal suspension that comprises between 35% w/w and 60% w/w of alkaline metal particles suspended in a neutral hydrophobic diluent.

2. The method for producing gaseous hydrogen according to claim 1, wherein the alkaline metal of colloidal suspension is metallic sodium or lithium.

3. The method for producing gaseous hydrogen according to claim 1, wherein the size of the alkaline metal particles of the colloidal suspension is less than 15 μm.

4. The method for producing gaseous hydrogen according to claim 1, wherein the size of the alkaline metal particles of the colloidal suspension is between 0.1 and 5 μm.

5. The method for producing gaseous hydrogen according to claim 1, wherein the neutral hydrophobic diluent of the colloidal suspension is an organic polymer that is selected from mineral oils.

6. The method for producing gaseous hydrogen according to claim 1, wherein the colloidal suspension comprises a dehydrating agent.

7. The method for producing gaseous hydrogen according to claim 2, wherein the size of the alkaline metal particles of the colloidal suspension is less than 15 μm.

8. The method for producing gaseous hydrogen according to claim 2, wherein the size of the alkaline metal particles of the colloidal suspension is between 0.1 and 5 μm.

9. The method for producing gaseous hydrogen according to claim 2, wherein the neutral hydrophobic diluent of the colloidal suspension is an organic polymer that is selected from mineral oils.

10. The method for producing gaseous hydrogen according to claim 3, wherein the neutral hydrophobic diluent of the colloidal suspension is an organic polymer that is selected from mineral oils.

11. The method for producing gaseous hydrogen according to claim 4, wherein the neutral hydrophobic diluent of the colloidal suspension is an organic polymer that is selected from mineral oils.

12. A process for the production of hydrogen, comprising bringing a colloidal suspension that comprises between 35% w/w and 60% w/w of alkaline metal particles that are suspended in a neutral hydrophobic diluent into contact with an aqueous solution, so as to produce gaseous hydrogen and an aqueous alkaline hydroxide emulsion.

13. The process for the production of hydrogen according to claim 12, wherein the aqueous solution is not in excess with respect to the colloidal suspension.

14. The process for the production of hydrogen according to claim 12, wherein the aqueous solution comprises demineralized purified water and an emulsifying surfactant.

15. The process for the production of hydrogen according to claim 14, wherein the emulsifying surfactant content is between 0.05% w/w and 2% w/w.
